(19) United States
(12) Patent Application Publication
(10) Pub. No.: US 2006/0167123 A1
(43) Pub. Date: Jul. 27, 2006

(54) Method for the production of low-bulk density polystyrene foam particles

(75) Inventors: Franz-Josef Dietzen, Hassloch (DE); Gerd Ehrmann, Deidesheim (DE); Klaus Hahn, Kirchheim (DE); Swen Ruck, Worms (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 10/525,767

(22) PCT Filed: Aug. 28, 2003
(86) PCT No.: PCT/EP03/09521

§ 371 Date: Feb. 28, 2005

(30) Foreign Application Priority Data
Sep. 4, 2002 (DE) 102 41 298.4

(51) Int. Cl. C08J 9/00

(52) U.S. Cl. 521/79

(57) ABSTRACT

A process for producing foam beads with low bulk density from thermoplastic polymers, encompassing the stages of a) addition of a blowing agent to a thermoplastic polymer melt, b) cooling and extrusion, through a die, of the polymer melt comprising blowing agent c) cutting of the polymer melt comprising-blowing agent downstream of the die at reduced pressure with foaming to give foam beads where water and a solubilizer are present in the blowing agent, and foam beads obtainable by the process.

The invention relates to a process for producing foam beads with low bulk density from thermoplastic polymers, by extruding a polymer melt comprising blowing agents, and also to foam beads obtainable by the process.

One way of producing polystyrene foam beads with low bulk densities in the range from 10 to 30 kg/m³ is foaming of expandable polystyrene granules (EPS) which comprise pentane, the granules being obtainable by suspension polymerization.

Equipment and a process for producing foam beads by extrusion have also been disclosed, but this process can only give relatively high bulk densities when using the pentane usually used as blowing agent for producing polystyrene foam beads.

An example of this type of process for producing discrete, closed-cell foam extrudates from polystyrene is described in EP-A 0 665 865. The blowing agents used comprise environmentally compatible blowing agent mixtures in which at least 20% by weight of carbon dioxide or ethane are present. In order to obtain relatively low bulk densities, a further stage has to be used to expand the foam extrudates, using heated air, or using steam.

EP-A 0 981 574 describes particulate expandable styrene polymers which comprise homogeneously distributed graphite particles to reduce thermal conductivity. One way of producing the compact pellets comprising blowing agent is to mix polystyrene, graphite, and pentane in a twin-screw extruder. The steam can then be used to foam the pellets to a relatively low density.

It is an object of the present invention to provide a process for producing foam beads from thermoplastic polymers which gives foam beads directly via extrusion of a polymer melt comprising blowing agent, with no additional expansion stages. The process should also be suitable for producing foam beads of relatively low bulk density which comprise IR absorber.

We have found that this object is achieved by means of a process for producing foam beads from thermoplastic polymers, encompassing the stages of
a) addition of a blowing agent to a thermoplastic polymer melt,
b) cooling and extrusion, through a die, of the polymer melt comprising blowing agent
c) cutting of the polymer melt comprising blowing agent downstream of the die at reduced pressure with foaming to give foam beads,
   where water and a solubilizer are present in the blowing agent.

According to the invention, the blowing agent comprises water, the amounts generally being in the range from 0.1 to 3% by weight, preferably in the range from 0.5 to 1.5% by weight, based on the thermoplastic polymer used.

In order to achieve maximum uniformity of distribution of the water in the thermoplastic polymer melt, the invention also adds a solubilizer. Suitable solubilizers are aliphatic alcohols, ketones, ethers, esters, or silicates. Preference is given to the use of ethanol. Suitable adsorbants are solids which can bind water physically or chemically, examples being aluminum hydroxide, phyllosilicates, or zeolites. The amounts generally used of the solubilizer or adsorbant are from 0.1 to 3% by weight, preferably amounts in the range from 1 to 2% by weight, based on the thermoplastic polymer used.

The conventionally used aliphatic, halogenated, or halogen-free hydrocarbons having from 3 to 10, preferably from 4 to 6, carbon atoms may also be present in the blowing agent, examples being isobutane, isopentane, n-pentane, or a mixture, and inert gases, such as carbon dioxide or nitrogen may be present, the amounts generally being in the range from 0.1 to 10% by weight, preferably from 0.3 to 7% by weight, based on the thermoplastic polymer used. It is particularly advantageous to use inert gases, such as carbon dioxide, as blowing agent in order to reduce emission of hydrocarbons during foam production.

The thermoplastic polymers used may comprise styrene polymers, such as glass-clear or impact-modified polystyrene, styrene copolymers with up to 20% by weight of ethylenically unsaturated comonomers, such as alpha-methylstyrene or acrylonitrile, or may comprise polyolefins, such as polyethylene or polypropylene, or a mixture of these polymers with one another or with polyphenylene ether.

Particularly low bulk densities may be achieved using thermoplastic polymers with broad molecular weight distribution. It is particularly preferable to use polystyrene with a polydispersity M_{w}/Mₙ of at least 2.5. It is also possible to use thermoplastic polymers with a bi- or multimodal molecular weight distribution. One way of producing these bi- or multimodal molecular weight distributions is to mix thermoplastic polymers of different molecular weight. It is particularly preferable to use low-molecular-weight polystyrene with a molar mass M_{w} in the range from 150,000 to 250,000 g/mol with high-molecular-weight polystyrene with a molar mass in the range from 280,000 to 500,000 g/mol, or with an ultrahigh-molecular-weight polystyrene with a molar mass of more than 1,000,000 g/mol. Even lower bulk densities may be achieved if a low-molecular-weight polymer, such as polystyrene with a molar mass in the range from 2,000 to 10,000 g/mol, is added to the thermoplastic polymer.

To reduce the thermal conductivity of the foam beads, infrared (IR) absorbers, such as graphite, aluminum powder, or carbon black, may be added to the thermoplastic polymers. Graphite has proven to be a particularly effective IR absorber. The amounts particularly preferably used of the IR absorbers are from 0.1 to 2.5% by weight, based on the thermoplastic polymer melt. The IR absorber may be fed into the thermoplastic polymer melt prior to or after addition of the blowing agent.

The usual additives, such as flame retardants, nucleating agents, UV stabilizers, plasticizers, pigments, and antioxidants, may be added to the thermoplastic polymer melt. The auxiliaries and IR absorbers may particularly preferably be in the form of additive masterbatches in the same thermoplastic polymer when added to the polymer melt. The foam particles obtained may moreover be coated with the known coating agents, such as metal stearates, glycerol esters, or fine-particle silicates.

A feature of the process of the invention is that it directly gives foam beads with a low bulk density, in particular with bulk densities below 30 kg/m³, in particular in the range from 15 to 25 kg/m³, which can be fused directly to give moldings without prefoaming. However, the foam beads of the invention may, for example, be prefoamed by heating, using steam, to give even lower bulk densities.

Static or dynamic mixers, such as extruders, are suitable for carrying out this process. The polymer melt discharged, comprising blowing agent, may be chopped to give pellets with the aid of rotating knives, for example in an underwater pelletizer or water-cooled die-face pelletizer. The pellets can be foamed to give foam beads via controlled depressurization.

### EXAMPLES

All of the percentage data relate to percentage by weight, based on the polymer melt.
PS 1: polystyrene with a melt index MVR (200° C./5 kg) of 10 cm³/10 min (ISO 1133, method H) and with a molar mass M_{w} of 190,000 g/mol
PS 2: polystyrene with a melt index MVR (200° C./5 kg) of 1.2 cm³/10 min (ISO 1133, method H) and with a molar mass M_{w} of 360,000 g/mol (PS 168 N from BASF AG)
PS ULM: polystyrene with a molar mass M_{w} of 4,600 g/mol
PS UHM: polystyrene with a molar mass M_{w} of 1,900,000 g/mol (Blendex from General Electric)

### Examples 1-9

Polystyrene PS 1 was melted together with 0.25% by weight of talc in a heated twin-screw extruder (ZSK 53), and the blowing agent composition given in Table 1 was fed, at a melt temperature of about 200° C. The melt comprising blowing agent was cooled and extruded through a die plate with holes of diameter 1.0 mm. The melt discharged was cut directly downstream of the die and on foaming at atmospheric pressure gave foam beads.

TABLE 1
Blowing agent composition and foam
properties from Examples 1 to 9

| | | | | | Thermal |
|---|---|---|---|---|---|
| | | | | Bulk | conductivity |
| Exam- | Water | Solubi- | Blowing agent | density | λ (23° C.) |
| ple | [%] | lizer [%] | added [%] | [kg/m³] | [mW/m*K] |
| 1 | 0.7 | 1.5% | 5% n-pentane | 26.4 | |
| | | ethanol | | | |
| 2 | 0.7 | 1.5% | 6% n-pentane | 22.3 | |
| | | ethanol | | | |
| 3 | 0.7 | 1.5% | 7% n-pentane | 19.6 | 32.9 |
| | | ethanol | | | |
| 4 | 0.7 | 1.5% | 6% isopentane | 17.6 | |
| | | ethanol | | | |
| 5 | 0.7 | 1.5% | 5% iso-butane | 18.2 | |
| | | ethanol | | | |
| 6 | 0.7 | 1.5% | 5% iso-butane | 18.8 | |
| | | acetone | | | |
| 7 | 0.7 | 1.8% | 5.5% tetrafluoro- | 19.2 | 32.7 |
| | | ethanol | ethane 134a | | |
| 8 | 0.7 | 1.5% | 3% CO₂ | 22.1 | |
| | | ethanol | | | |
| 9 | 0.7 | 1.5 | 4% CO₂ | 22.4 | |
| | | ethanol | | | |

Comparative Experiments:

Examples 1-9 gave higher bulk densities when water and solubilizer were not added.

### Examples 10-12

Example 9 was repeated using the polystyrene mixtures set out in Table 2.

TABLE 2

| | Polystyrene mixture (propor- | |
|---|---|---|
| Example | tions by weight) | Bulk density [kg/m³] |
| 10 | PS 1/PS 2 (75/25) | 18.8 |
| 11 | PS 1/PS UHM (95/5) | 17.2 |
| 12 | PS 1/PS ULM/PS UHM (85/10/5) | 16.6 |

### Examples 13-15

Example 2 is repeated, but the proportions by weight of graphite given in Table 3 were added to the polystyrene instead of talc.

TABLE 3

| | | | Thermal |
|---|---|---|---|
| | Graphite | Bulk density | conductivity |
| Example | [% by weight] | [kg/m³] | λ (23° C.) [mW/m*K] |
| 13 | 0.25 | 18.7 | 30.8 |
| 14 | 0.50 | 18.1 | 27.2 |
| 15 | 1.00 | 18.4 | 26.4 |

1. A process for producing foam beads from thermoplastic polymers, encompassing the stages of
a) addition of a blowing agent to a thermoplastic polymer melt,
b) cooling and extrusion, through a die, of the polymer melt comprising blowing agent,
c) cutting of the polymer melt comprising blowing agent downstream of the die at reduced pressure with foaming to give foam beads,
which comprises using a blowing agent in which water and a solubilizer or adsorbent are present.

2. A process as claimed in claim 1, wherein the solubilizer used comprises an aliphatic alcohol, ketone, ether, or ester.

3. A process as claimed in claim 1, wherein the adsorbent used comprises aluminum hydroxide, phyllosilicate, or zeolite.

4. A process as claimed in claim 1, wherein the blowing agent also comprises CO₂, N₂, or an aliphatic, halogenated, or halogen-free hydrocarbon.

5. A process as claimed in claim 4, wherein the blowing agent used comprises a mixture of
from 0.1 to 3% by weight of water,
from 0.1 to 3% by weight of an alcohol or ketone, and
from 1 to 10% by weight of an aliphatic, halogenated, or halogen-free hydrocarbon, or CO₂.

6. A process as claimed in claim 1, wherein the thermoplastic polymer used comprises polystyrene, styrene copolymers, polyethylene, polypropylene, or a mixture of these.

7. A process as claimed in claim 1, wherein the thermoplastic polymer has a bi- or multimodal molecular weight distribution.

8. A process as claimed in claim 1, wherein the thermoplastic polymer used comprises polystyrene with a polydispersity M_{w}/Mₙ of at least 2.5.

9. A process as claimed in claim 1, wherein, prior to or after addition of the blowing agent, an IR absorber is added to the thermoplastic polymer melt.

10. A process as claimed in claim 9, wherein the IR absorber used comprises from 0.1 to 2.5% by weight based on the thermoplastic polymer melt, of graphite, carbon black, or aluminum powder.

11. A process as claimed in claim 2, wherein the adsorbent used comprises aluminum hydroxide, phyllosilicate, or zeolite.

12. A process as claimed in claim 2, wherein the blowing agent also comprises CO₂, N₂, or an aliphatic, halogenated, or halogen-free hydrocarbon.

13. A process as claimed in claim 3, wherein the blowing agent also comprises CO₂, N₂, or an aliphatic, halogenated, or halogen-free hydrocarbon.

14. A process as claimed in claim 2, wherein the thermoplastic polymer used comprises polystyrene, styrene copolymers, polyethylene, polypropylene, or a mixture of these.

15. A process as claimed in claim 3, wherein the thermoplastic polymer used comprises polystyrene, styrene copolymers, polyethylene, polypropylene, or a mixture of these.

16. A process as claimed in claim 4, wherein the thermoplastic polymer used comprises polystyrene, styrene copolymers, polyethylene, polypropylene, or a mixture of these.

17. A process as claimed in claim 5, wherein the thermoplastic polymer used comprises polystyrene, styrene copolymers, polyethylene, polypropylene, or a mixture of these.

18. A process as claimed in claim 2, wherein the thermoplastic polymer has a bi- or multimodal molecular weight distribution.

19. A process as claimed in claim 3, wherein the thermoplastic polymer has a bi- or multimodal molecular weight distribution.

20. A process as claimed in claim 4, wherein the thermoplastic polymer has a bi- or multimodal molecular weight distribution.
